(19) United States
(12) Patent Application Publication
(10) Pub. No.: US 2014/0279439 A1
(43) Pub. Date: Sep. 18, 2014

(54) METHOD AND APPARATUS FOR CONFIGURING A TRANSACTION TO ADHERE TO JURISDICTION-DEPENDENT REGULATIONS

(71) Applicant: Wendell Brown, Neveda, CA (US)

(72) Inventor: Wendell Brown, Neveda, CA (US)

(21) Appl. No.: 14/206,863

(22) Filed: Mar. 12, 2014

Related U.S. Application Data
(60) Provisional application No. 61/778,173, filed on Mar. 12, 2013.

(51) Int. Cl. G06Q 20/10; G06Q 30/00

(52) U.S. Cl. CPC G06Q 20/10; G06Q 30/018
USPC 705/39

(57) ABSTRACT

Methods, systems, computer-readable media, and apparatuses for facilitating a transaction are presented. In some embodiments, a request to participate in the transaction with one or more other users is received from a user device. The one or more other users are determined to ensure that the transaction is classified as an interstate transaction and complies with federal regulations governing the transaction. The transaction between the user and the one or more other users is facilitated based at least in part on the determining. The transaction may be an online gambling transaction.

This application claims the benefit of U.S. Provisional Application No. 61/778,173, filed Mar. 12, 2013, entitled “METHOD AND APPARATUS FOR CONFIGURING A TRANSACTION TO ADHERE TO JURISDICTION-DEPENDENT REGULATIONS” which is incorporated herein by reference.

### BACKGROUND

Aspects of the disclosure relate to jurisdiction-dependent transactions. More specifically, aspects of the disclosure relate to methods for ensuring jurisdictional diversity for various transactions.

Internet gaming and gambling has become one of the most lucrative businesses on the Internet. Various United States regulations, at both the federal and state levels, regulate gambling involving currency. Typically, gaming can be divided into two categories: “games of chance” and “games of skill”. Games of chance are games that involve an element of luck. For example, games of chance include, but are not limited to, rolling dice, picking of cards, spinning of a roulette wheel, etc. Games of skill are games that involve an element of skill (e.g., chess) and/or dexterity (e.g., golf). These games are regulated under different laws depending on whether federal law or state law applies.

Federal regulations typically apply when a transaction (or game) qualifies as an “interstate” transaction. Interstate transactions are transactions that occur across state lines. On the other hand, state regulations typically apply when a transaction (or game) does not qualify as an interstate transaction. Article VI of the United States Constitution makes federal law “the supreme law of the land,” notwithstanding the contrary law any state might have. This constitutional law is otherwise known as the “Supremacy Clause” which dictates that federal law preempts state law. Often times, federal law may be more advantageous for a particular transaction than state law, or vice versa.

Accordingly, a need exists for configuring a transaction to adhere to jurisdiction-dependent regulations.

### BRIEF SUMMARY

Certain embodiments are described that relate particularly to systems, methods, apparatus, and computer products for selecting the structure and routing of interstate transactions to ensure that they comply with applicable laws, which may be selected from multiple possible jurisdictions. More specifically, embodiments of the invention relate to the selection of transaction methods, selection of participants entered into transactions, and other transaction structures and algorithms, as implemented in software and/or hardware that run on one or more computing devices.

In some embodiments, a method for facilitating a transaction includes receiving, from a user device, a request to participate in the transaction with one or more other users. The method also includes determining, via a server computer, the one or more other users to ensure that the transaction is classified as an interstate transaction and complies with federal regulations governing the transaction. The method additionally includes facilitating, via the server computer, the transaction between the user and the one or more other users based at least in part on the determining step.

In some embodiments, the transaction is an online gambling transaction.

In some embodiments, the transaction is an online lottery transaction.

In some embodiments, the transaction is an online skill-based game transaction.

In some embodiments, the transaction is an online sweepstakes transaction.

In some embodiments, the transaction is a sports-related transaction.

In some embodiments, the transaction is a sports-related or sports-event transaction.

In some embodiments, the transaction is a race or off-track racing transaction.

In some embodiments, the federal regulations govern transactions occurring across at least a first jurisdiction and a second jurisdiction.

In some embodiments, the transaction is classified as an interstate transaction if the first jurisdiction is different from the second jurisdiction, wherein the first jurisdiction is associated with the user and the second jurisdiction is associated with at least one of the one or more other users.

In some embodiments, the transaction is classified as an interstate transaction if the first jurisdiction is different from the second jurisdiction, wherein the first jurisdiction is associated with the user and the second jurisdiction is associated with the server computer.

In some embodiments, the transaction is classified as an interstate transaction if the first jurisdiction is different from the second jurisdiction, wherein the first jurisdiction is associated with the user and the second jurisdiction is associated with at least one of a payment processor, transactional clearinghouse, or escrow agent associated with the transaction.

In some embodiments, the method also includes assigning the user and at least one of the one or more other users to a first team and assigning a plurality of the one or more other users to a second team, wherein the user and at least one of the one or more other users to the first team are associated with at least the first jurisdiction and the plurality of the one or more other users assigned to the second team are associated with at least the second jurisdiction.

In some embodiments, the first jurisdiction is a first state of the United States and the second jurisdiction is a second state of the United States.

In some embodiments, the first jurisdiction is a first state of the United States and the second jurisdiction is a jurisdiction outside of the United States.

In some embodiments, the first jurisdiction is a first state of the United States and the second jurisdiction is a sovereign or other similar territory (such as an Indian reservation) within the United States.

In some embodiments, the first jurisdiction is a first state of the United States and the second jurisdiction is a territory (such as Guam, Puerto Rico, etc.) of the United States.

In some embodiments, the method also includes sending a notification to the one or more other users to participate in the transaction.

In some embodiments, the notification is sent via a social network in which the user and the one or more other users are enrolled.

In some embodiments, the method also includes requesting, from the user device, a jurisdictional location of the user device, wherein the jurisdictional location is determined using Global Positioning System (GPS) techniques.

In some embodiments, the method also includes a method of determining the location of the user/the user's device, and thereby determining the jurisdiction of the user, by detecting the specific mobile phone tower, or towers, the device is communicating with, and then indexing into a “tower database” of latitude/longitudes for that particular tower.

In some embodiments, the determining step further comprises selecting the one or more other users from a pool of users eligible to participate in the transaction.

In some embodiments, the method also includes, after facilitating the transaction, adding additional users from the pool of users to participate in the transaction, wherein the additional users from the pool of users are different from the one or more other users, and wherein the additional users are added to participate in the transaction to maximize jurisdictional diversity between the user, the one or more other users, and the additional users.

In some embodiments, the determining step further comprises determining the one or more other users based at least in part on a skill-level associated with the user and the one or more other users.

In some embodiments, the determining step further comprises determining the one or more other users based at least in part on at least one of age, sex, or educational level associated with the user and the one or more other users.

In some embodiments, a server for facilitating a transaction includes, a processor and a non-transitory computer-readable storage medium, comprising code executable by the processor for implementing a method. The method includes receiving, from a user device, a request to participate in the transaction with one or more other users. The method also includes determining the one or more other users to ensure that the transaction is classified as an interstate transaction and complies with federal regulations governing the transaction. The method additionally includes facilitating the transaction between the user and the one or more other users based at least in part on the determining step.

### BRIEF DESCRIPTION OF THE DRAWINGS

Aspects of the disclosure are illustrated by way of example. In the accompanying figures, like reference numbers indicate similar elements, and:

FIG. 1 is a block diagram of a server computer, according to an embodiment of the present invention.

FIG. 2 illustrates a map of the United States illustrating users across different states, according to an embodiment of the present invention.

FIG. 3 is a flowchart illustrating a method of ensuring jurisdictional diversity in a transaction, according to some embodiments of the invention.

FIG. 4 illustrates an online gambling game running on a mobile device, according to some embodiments of the invention.

FIG. 5 is a flowchart illustrating a method for facilitating a transaction, according to embodiments of the invention.

FIG. 6 is a diagram of a computer apparatus, according to an example embodiment.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

In the following description, the term “jurisdictional diversity” may refer to where the users participating in the transaction are “diverse” in jurisdiction, which generally indicates that they are located within different states. In some embodiments, the term “diverse” may mean that the users' associated permanent home address is within different states.

In the following description, the term “transaction” may generally refer to a single element within a game, an entire game, a tournament, a portion of a tournament, a single player game, a multiple player game, or other such games.

In the following description, the term “game” or “games” may generally refer to word games, graphics games, timing games, skill games, muscle skill games, games involving the motion/rotation/movement of the wireless computing device, games involving memory, sound, sight, motion, first, second, and third perspective games, games involving timing, or any other type of game.

FIG. 1 is a block diagram of a server computer 100, according to an embodiment of the present invention. Server computer 100 includes an input/output interface 110, a memory 120, a processor 130, a user database 140, a jurisdictional regulations database 150, and a computer-readable medium 160. In some embodiments, the server computer may reside within an interconnected network.

The input/output (I/O) interface 110 is configured to receive and transmit data. For example, the I/O interface 110 may receive and/or transmit data pertaining to a transaction. The I/O interface 110 may also be used for direct interaction with the server computer. The I/O interface 110 may accept input from an input device such as, but not limited to, a keyboard, keypad, or mouse. Further, the I/O interface may display output on a display device.

Memory 120 may be any magnetic, electronic, or optical memory. It can be appreciated that memory 120 may include any number of memory modules. An example of memory 120 may be dynamic random access memory (DRAM).

Processor 130 may be any general-purpose processor operable to carry out instructions on the server computer 100. The processor 130 is coupled to other units of the server computer 100 including input/output interface 110, memory 120, user database 140, jurisdictional regulations database 150, and computer-readable medium 160.

The user database 140 may be configured to store information about a pool of users eligible to participate in various transactions. For example, the user database 140 can include information about a pool of users eligible to participate in an online blackjack game. The user database 140 can include attributes pertaining to the users, including, but not limited to, residence state, current state, name, age, phone number, current account balance, skill level, sex, etc. The user database 140 may be updated in real-time by the server computer 100 when one or more attributes pertaining to the user(s) change. For example, if the current state of the user changes (e.g., the user crosses a state line), the server computer 100 may update the user database 140 to reflect this change. In some embodiments, the user database 140 may be populated with attributes pertaining to a new user when the user registers with the server computer 100 or another computer interconnected with the server computer 100 via the interconnected network.

The jurisdictional regulations database 150 may be configured to store information about jurisdictional regulations as they pertain to various transactions. The jurisdictional regulations database 150 may store both state-specific and federal regulations that pertain to the various transactions. For example, the jurisdiction regulations database 150 could include information about: Nevada state blackjack laws, Texas state roulette laws, United States interstate transaction laws, United States online gambling laws, etc. It can be appreciated that the jurisdictional regulations database 150 may be updated in real-time by the server computer 100 to reflect the latest information regarding both the state-specific and federal regulations.

Computer-readable medium 160 may be any magnetic, electronic, optical, or other computer-readable storage medium. Computer-readable storage medium 160 includes transaction facilitation module 162. Computer-readable storage medium 160 may comprise any combination of volatile and/or non-volatile memory such as, for example, buffer memory, RAM, DRAM, ROM, flash, or any other suitable memory device, alone or in combination with other data storage devices.

The transaction facilitation module 162 may be configured to facilitate a transaction between the users within the user pool stored in the user database 140. The transaction facilitation module 162 may also interface with the jurisdictional regulations database 150 to determine which users from the user pool may be the most well-suited to be participate in the transaction based on the desire to qualify the transaction to apply to a specific jurisdictional regulations governing the transaction. For example, the transaction facilitation module 162 may facilitate a transaction between two users living in different jurisdictions (e.g., states) so that the transaction qualifies as an interstate transaction and federal regulations would apply to the transaction. In some embodiments, the transaction could be an online gambling transaction. It can be appreciated that the desired qualification of the transaction to apply to the specific jurisdictional regulation may vary with each transaction. For example, at times federal regulations governing the transaction may be desired while at other times state-specific regulations governing the transaction may be desired. Details of the functionality of the transaction facilitation module 162 are discussed further herein.

FIG. 2 illustrates a map 200 of the United States illustrating users 210 across different states, according to an embodiment of the present invention. The map 200 shows four users 210, each user 210 associated with a mobile device 220. It can be appreciated that the embodiments described herein may apply to any number of users. At least one of the users 410 may wish to engage in a transaction with one or more of the other users 410, e.g., an online gambling transaction. As described above, the transaction facilitation module 162 (FIG. 1) may be configured to select the structure and routing of the transaction so as to comply with a specific jurisdictional regulation. The desired specific jurisdiction may be selected from multiple possible jurisdictions, about which information is stored is within the jurisdictional regulations database 150. More specifically, in the case of online gambling, the transaction facilitation module 162 (FIG. 1) can select betting methods, users 210 entered into the gambling transaction, and other transaction structures and algorithms. In some embodiments, it may be desired to qualify the online gambling transaction as an interstate transaction such that it is governed by federal regulations.

The illustration in FIG. 2 shows four users 210 located within different states. A first user is located within California (CA), a second user is located within Montana (MT), a third user is located within Minnesota (MN), and a fourth user is located within Texas (TX). One of the users 410 may indicate to the server computer 100 (FIG. 1) that he/she wants to participate in an online gambling transaction. For example, the user 410 could open an online gambling application on his/her mobile device 220 and select an option for joining a game. The user could be presented with the option to create a new game or join an existing game. It can be appreciated that the selected game may provide advantages if it were governed by federal regulations rather than state-specific regulations. In such cases, as described above, the transaction facilitation module 162 (FIG. 1) may qualify the online gambling transaction as an interstate transaction such that it is governed by federal regulations. Qualification of the online gambling transaction as an interstate transaction may be accomplished by ensuring jurisdictional diversity between the user indicating he/she wants to participate in the online gambling transaction and other potential users that may be selected to participate in the online gambling transaction.

For example, the user 210 from Texas may indicate, via his/her mobile device 220, that he/she wants to participate in a blackjack game (e.g., online gambling transaction). The request may be received by the server computer 100 (FIG. 1). The server computer 100 may then query the user database 140 (FIG. 1) to determine attributes about the user (e.g., age, sex, location, skill level, etc.). In some embodiments, the location of the user may be determined using GPS techniques. Other techniques for determining the location of the user can include, but is not limited to, cell tower triangulation or other location-sensing inputs of the user's wireless computing device. In this example, the server computer 100 (FIG. 1) may determine that the user 210 is located within Texas. The server computer 100 (FIG. 1) may also query the jurisdictional regulations database 150 (FIG. 1) to determine which regulations are most favorable for the blackjack game. For example, the blackjack game may be more favorable under federal regulations. As such, the server computer 100 (FIG. 1) may qualify the blackjack game as an interstate transaction by ensuring that the user 210 is placed into a blackjack game with other users 210, where at least one of the users 210 is in a state different than the requesting user 210 from Texas. For example, if the user 210 from CA is also requesting to participate in a blackjack game, the server computer 100 (FIG. 1) may facilitate a blackjack game between the user 210 from CA and the user 210 from TX. In some embodiments, the server computer 100 (FIG. 1) may send a notification to the user 210 from CA's mobile device 220 requesting the user 210 from CA to join the blackjack game. This notification may be sent via a variety of communications channels, e.g., text message, e-mail, push notification, social network message, etc. It can be appreciated that the server computer 100 (FIG. 1) may also request participation from other users 210 from TX or other users from different states so long as at least one active user 210 in the blackjack game is from a different state than the rest of the users 210.

In some embodiments, if user 210 from TX is first user to join the blackjack game, the server computer 100 (FIG. 1), via transaction facilitation module 162 (FIG. 1), may ensure that the next user to join the blackjack game is from a state different than the user 210 from TX. In some embodiments, if another user 210 from TX is allowed to join the game, the server computer 100 (FIG. 1) may delay the start of the blackjack game until it can facilitate the participation of a user 210 from a state other than TX.

In some embodiments, if only one user 210 in the blackjack game makes for jurisdictional diversity (e.g., 3 users are from TX and one user is from MT), and that user 210 drops out from the blackjack game, the server computer 100 (FIG. 1) via transaction facilitation module 162 (FIG. 1), may delay continuation of the blackjack game until another user 210 from a state other than TX joins the blackjack game.

In some embodiments, thousands of users 210 may exist in each state and be part of the user pool located within the user database 140 (FIG. 1). The sever computer 210 (FIG. 1), via transaction facilitation module 162 (FIG. 1), may compute various combinations and permutations of user combinations and then filter the wide universe of user combinations to a more limited collection of user combinations such that jurisdictional diversity is maintained throughout the blackjack game.

At times, it may desirable to maximize the jurisdictional diversity in the online gambling transaction. For example, of the online gambling transaction typically involves ten users, it may be desirable to have as many of the ten users as possible to be located within different states. In an illustrative example, one may consider the following user pool: ten users from WA, five users from OR, three users from CA, six users from NV, four users from ID, seven users from UT, and four users from AZ. That is, a user pool of 39 users from seven different states. To maximize jurisdictional diversity, the server computer 100 (FIG. 1), via transaction facilitation module 162 (FIG. 1), may ensure that at least one user from each of the seven states is selected, with the remaining three users from any of the states. An example of the ten users selected to participate in the online gambling transaction may include: one users from WA, two users from OR, one users from CA, one users from NV, two users from ID, one users from UT, and two users from AZ.

Certain online gambling transactions may only require one user 210 to participate. For example, games played against the “house” (e.g., casino war) may only require one user 210 to participate. In such a case, jurisdictional diversity may be established if the server computer 100 (FIG. 1) is located within a state other than the user. However, in cases where the user 210 is located within the same state as the server computer 100 (FIG. 1), the server computer 100 (FIG. 1) may, via transaction facilitation module 162 (FIG. 1), reroute the transaction to another server computer within the interconnected network that is located in a state different from the user. Similarly, the server computer 100 (FIG. 1), via transaction facilitation module 162 (FIG. 1), may also establish jurisdictional diversity by selectively routing the user to a specific clearinghouse agent, payment processor, or escrow agent that may be located in a different state than the user 210. More generally, any entity associated with the transaction that may be located in a different state than the user 210 may be added to the transaction to establish jurisdictional diversity. These techniques may also be employed, to establish jurisdictional diversity, in multiuser online gambling transactions where the users are located within the same state.

In some embodiments, the server computer 100 (FIG. 1) may, via transaction facilitation module 162 (FIG. 1), issue play tokens, play credits, or other user or credit instruments from a source located within a state different from at least one of the user's 210 states.

In some embodiments, the server computer 100 (FIG. 1), via transaction facilitation module 162 (FIG. 1), may assign the users 210 to different teams of players such that at least one user team member is located in a different state than at least one other user team member. Alternatively, the teams may be arranged such that multiple user team members are located in different states than at one other user team member.

In some embodiments, multiple online gambling transactions may be active. In some instances, a user 210 that is the sole user used in establishing jurisdictional diversity in an online gambling transaction may leave the game. As such, the jurisdictional diversity of that game may no longer exist. In response, the server computer 100 (FIG. 1) may, via transaction facilitation module 162 (FIG. 1), transfer a user 210 participating in another, but identical or nearly identical, online gambling transaction to the present online gambling transaction if that user 210 is not the sole basis of jurisdictional diversity. For example, two users from TX and one user from CA may be participating in a blackjack game when the user from CA drops out of the game. As a result, jurisdictional diversity is no longer established. Meanwhile, another blackjack game may include a user from MT, a user from ND, and a user from AR. The server computer 100 (FIG. 1), via transaction facilitation module 162 (FIG. 1), may move or transfer any of the users from the second blackjack game to the first blackjack game to once again establish jurisdictional diversity.

In some embodiments, the server computer 100 (FIG. 1), via transaction facilitation module 162 (FIG. 1), may group the users 210 from the user pool based on their skill-level associated with the game, while still maintaining jurisdictional diversity across the users. The users 210 may be grouped such that similar skill-levels are represented across the users 210 in the same game. In other embodiments, the server computer 100 (FIG. 1), via transaction facilitation module 162 (FIG. 1), may group the users 210 from the user pool based on other criteria such as, but not limited to, age, sex, education level, etc. while still maintaining jurisdictional diversity across the users.

In some embodiments, the server computer 100 (FIG. 1), via transaction facilitation module 162 (FIG. 1), may link the ability of a transaction's payout status to the final determination of each of users' 210 location. For example, the payout status of a particular online gambling transaction may be linked to a determination of the users' 210 location, which ultimate may determine the jurisdictional regulation that governs the transaction.

FIG. 3 is a flowchart 300 illustrating a method of ensuring jurisdictional diversity in a transaction, according to some embodiments of the invention. In some embodiments, the transaction can be an online gambling transaction in the form of an online game. In block 310, the game is initialized. The game may be initialized in response to a user action, e.g., opening a gaming application on the user's mobile device. In some embodiments, the game may be initialized by the server computer 100 (FIG. 1).

In block 320, the server computer 100 (FIG. 1) may determine a number of users and locations of the users wanting to play, or currently playing, the game. The server computer 100 (FIG. 1) may interface with the user database 140 to determine eligible users for the game. In some embodiments, the locations of the users may be determined using GPS technologies.

In block 330, the locations of the users wanting to play, the server computer 100 (FIG. 1) may determine whether the users' locations are from at least two different states. The determination may be made in regards to users that are currently playing the game, users wanting to play the game, or a combination of both. If the users' locations are not from at least two different states, the method continues to block 340. If the users' locations are from at least two different states, the method continues to block 350.

In block 340, in response to determining that the users' locations are not from two different states, the server computer 100 (FIG. 1) may add a user from a different state to the game. For example, if the game currently has two users from TX, the server computer 100 (FIG. 1) may add a user from CA. In another example, if two users currently want to play the game, a new game may be created with the two users after determining that the two users are from different states.

In block 350, the server computer 100 (FIG. 1), if it is not located in a different state from at least one of the users in the game, may determine another server computer 100 (FIG. 1) that is part of the interconnected network to facilitate the game. It can be appreciated that block 350 may be optional if a user from a different state is added in block 340. If only one user is available or eligible to play the game, the selection of the transaction server in a different state from the user may establish jurisdictional diversity.

In block 360, the server computer 100 (FIG. 1) may begin the game. For example, the game could be a blackjack game.

FIG. 4 illustrates an online gambling game running on a mobile device 220, according to some embodiments of the invention. The mobile device includes a display 410, and a user input button 420. The display 410 is configured to display a GUI representing an online gambling game. In this example, a blackjack game is shown. The GUI shows the blackjack cables, chips, cards, and other associated content. Additionally, the GUI shows the names of users currently playing the game, their location, and current game balance. As shown in the example, each of the three players currently playing the blackjack game are from different states. As such, jurisdictional diversity is established for the blackjack game, and the blackjack game may be governed by federal regulations.

If all the users were from the state, the server computer 100 (FIG. 1) may find another user from a different state to join to the blackjack game to establish jurisdictional diversity.

The users shown the example in FIG. 4 may all access the online gambling game from their own respective mobile devices 220. In some embodiments, one or more users may access the online gambling game from a personal computer, tablet device, or other network equipped device.

FIG. 5 is a flowchart 500 illustrating a method for facilitating a transaction, according to embodiments of the invention. In block 510, a request to participate in a transaction with or more other users is received from a user device. The request may be received by the server computer over an interconnected network. The transaction may be an online gambling transaction in the form of an online game.

In block 520, the one or more other users are determined to ensure that the transaction is classified as an interstate transaction and complies with federal regulations governing the transaction. The federal regulations may govern transactions occurring across at least a first jurisdiction and a second jurisdiction.

The transaction may be classified as an interstate transaction if the first jurisdiction is different from the second jurisdiction, where the first jurisdiction is associated with the user and the second jurisdiction is associated with at least one of the one or more other users. In some embodiments, the transaction is classified as an interstate transaction if the first jurisdiction is different from the second jurisdiction, where the first jurisdiction is associated with the user and the second jurisdiction is associated with the server computer. In some embodiments, the transaction is classified as an interstate transaction if the first jurisdiction is different from the second jurisdiction, where the first jurisdiction is associated with the user and the second jurisdiction is associated with at least one of a payment processor, transactional clearinghouse, or escrow agent associated with the transaction.

The user may be and at least one of the one or more other users may be assigned to a first team and a plurality of the one or more other users may be assigned to a second team, where the user and at least one of the one or more other users assigned to the first team are associated with at least the first jurisdiction and the plurality of the one or more other users assigned to the second team are associated with at least the second jurisdiction.

The first jurisdiction may be a first state of the United States and the second jurisdiction may be a second state of the United States.

The server computer may send a notification to the one or more other users requesting them to participate in the transaction. The notification may be sent to the one or more other users' mobile devices. In some embodiments, the notification may be sent over a social network.

In order to determine the locations of the users, the server computer may determine the location of his/her mobile devices using GPS technologies. The users may also be determined based at least in part on a skill-level associated with the user and the one or more other users. Additionally, the determination could be based on age, sex, educational level, etc.

The users may then be picked from a pool of users determined to be eligible to participate in the transaction. Additional users may be added at any stage of the transaction to maximize jurisdiction diversity of the users participating in the transaction.

In block 530, the transaction between the user and the one or more other users is facilitated based at least in part on the determining step. New users may be added to the transaction at any time to ensure that jurisdictional diversity is maintained.

FIG. 6 is a diagram of a computer apparatus 600, according to an example embodiment. The various participants and elements in the previously described system diagram (e.g., the server computer in FIG. 1 or user devices in FIG. 2) may use any suitable number of subsystems in the computer apparatus to facilitate the methods and/or functions described herein. Examples of such subsystems or components are shown in FIG. 6. The subsystems shown in FIG. 6 are interconnected via a system bus 605. Additional subsystems such as a printer 640, keyboard 670, fixed disk 680 (or other memory comprising computer-readable media), monitor 655, which is coupled to display adapter 650, and others are shown. Peripherals and input/output (I/O) devices (not shown), which couple to I/O controller 610, can be connected to the computer system by any number of means known in the art, such as serial port 660. For example, serial port 660 or external interface 690 can be used to connect the computer apparatus to a wide area network such as the Internet, a mouse input device, or a scanner. Alternatively, peripherals can be connected wirelessly (e.g., IR, Bluetooth, etc.). The interconnection via system bus allows the central processor 630 to communicate with each subsystem and to control the execution of instructions from system memory 620 or the fixed disk 680, as well as the exchange of information between subsystems. The system memory 620 and/or the fixed disk 580 (e.g., hard disk, solid state drive, etc.) may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

It can be appreciated that while the transactions described herein are generally described with reference to online gambling transactions, they are not limited to just online gambling transactions. The systems and methods described herein may apply to any type of transaction.

In embodiments, any of the entities described herein may be embodied by a computer that performs any or all of the functions and steps disclosed.

Any recitation of “a”, “an” or “the” is intended to mean “one or more” unless specifically indicated to the contrary.

One or more embodiments of the invention may be combined with one or more other embodiments of the invention without departing from the spirit and scope of the invention.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for facilitating a transaction, comprising:
receiving, from a user device, a request to participate in the transaction with one or more other users;
determining, via a server computer, the one or more other users to ensure that the transaction is classified as an interstate transaction and complies with federal regulations governing the transaction; and
facilitating, via the server computer, the transaction between the user and the one or more other users based at least in part on the determining step.

2. The method of claim 1, wherein the transaction is an online gambling transaction.

3. The method of claim 1, wherein the federal regulations govern transactions occurring across at least a first jurisdiction and a second jurisdiction.

4. The method of claim 3, wherein the transaction is classified as an interstate transaction if the first jurisdiction is different from the second jurisdiction, wherein the first jurisdiction is associated with the user and the second jurisdiction is associated with at least one of the one or more other users.

5. The method of claim 3, wherein the transaction is classified as an interstate transaction if the first jurisdiction is different from the second jurisdiction, wherein the first jurisdiction is associated with the user and the second jurisdiction is associated with the server computer.

6. The method of claim 3, wherein the transaction is classified as an interstate transaction if the first jurisdiction is different from the second jurisdiction, wherein the first jurisdiction is associated with the user and the second jurisdiction is associated with at least one of a payment processor, transactional clearinghouse, or escrow agent associated with the transaction.

7. The method of claim 3, further comprising assigning the user and at least one of the one or more other users to a first team and assigning a plurality of the one or more other users to a second team, wherein the user and at least one of the one or more other users assigned to the first team are associated with at least the first jurisdiction and the plurality of the one or more other users assigned to the second team are associated with at least the second jurisdiction.

8. The method of claim 3 wherein the first jurisdiction is a first state of the United States and the second jurisdiction is a second state of the United States.

9. The method of claim 1, further comprising sending a notification to the one or more other users to participate in the transaction.

10. The method of claim 9, wherein the notification is sent via a social network in which the user and the one or more other users are enrolled.

11. The method of claim 1, further comprising requesting, from the user device, a jurisdictional location of the user device, wherein the jurisdictional location is determined using Global Positioning System (GPS) techniques.

12. The method of claim 1, wherein the determining step further comprises selecting the one or more other users from a pool of users eligible to participate in the transaction.

13. The method of claim 12, further comprising, after facilitating the transaction, adding additional users from the pool of users to participate in the transaction, wherein the additional users from the pool of users are different from the one or more other users, and wherein the additional users are added to participate in the transaction to maximize jurisdictional diversity between the user, the one or more other users, and the additional users.

14. The method of claim 1, wherein the determining step further comprises determining the one or more other users based at least in part on at least one of a skill-level, age, sex, or educational level associated with the user and the one or more other users.

15. A server for facilitating a transaction, comprising:
a processor, and
a non-transitory computer-readable storage medium, comprising code executable by the processor for implementing a method comprising:
receiving, from a user device, a request to participate in the transaction with one or more other users;
determining the one or more other users to ensure that the transaction is classified as an interstate transaction and complies with federal regulations governing the transaction; and
facilitating the transaction between the user and the one or more other users based at least in part on the determining step.

16. The server of claim 15, wherein the federal regulations govern transactions occurring across at least a first jurisdiction and a second jurisdiction.

17. The server of claim 16, wherein the transaction is classified as an interstate transaction if the first jurisdiction is different from the second jurisdiction, wherein the first jurisdiction is associated with the user and the second jurisdiction is associated with at least one of the one or more other users.

18. The server of claim 16, wherein the transaction is classified as an interstate transaction if the first jurisdiction is different from the second jurisdiction, wherein the first jurisdiction is associated with the user and the second jurisdiction is associated with the server.

19. The server of claim 16, wherein the transaction is classified as an interstate transaction if the first jurisdiction is different from the second jurisdiction, wherein the first jurisdiction is associated with the user and the second jurisdiction is associated with at least one of a payment processor, transactional clearinghouse, or escrow agent associated with the transaction.

20. A method for facilitating a transaction, comprising:
receiving, from a user device, a request to participate in the transaction;
determining, via a server computer, an entity to associate with the transaction to ensure that the transaction is classified as an interstate transaction and complies with federal regulations governing the transaction; and
facilitating, via the server computer, the transaction between the user and the entity based at least in part on the determining step.
